(19) United States
(12) Patent Application Publication
(10) Pub. No.: US 2025/0058539 A1
(43) Pub. Date: Feb. 20, 2025

(54) APPARATUS FOR FORMING A BLANK

(71) Applicant: Kool Global Solutions Pty Ltd, Kurrimine Beach, Queensland (AU)

(72) Inventor: Tom Joseph Long, Queensland (AU)

(73) Assignee: Kool Global Solutions Pty Ltd, Kurrimine Beach, Queensland (AU)

(21) Appl. No.: 18/721,908

(22) PCT Filed: Dec. 13, 2022
(86) PCT No.: PCT/AU2022/051494

§ 371 Date: Jun. 20, 2024

(30) Foreign Application Priority Data
Dec. 20, 2021 (AU) 2021904149

(51) Int. Cl. B30B 15/06

(52) U.S. Cl. CPC B30B 15/062

(57) ABSTRACT

A profiled press plate for forming a blank from two or more layers of sheet material in a platen press, comprising:
a profiled press plate comprising a first profile portion on a surface thereof, the first profile portion being configured to compress the two or more layers of sheet material to form a seal therebetween about at least a portion of a periphery of the blank, the plate portion further comprising a second profile portion on a surface thereof, the second profile portion being located inwardly of the first profile portion and configured to compress the two or more layers of sheet material to form fold lines therein,
wherein the profiled press plate includes one or more inlets in fluid communication with a source of fluid and one or more outlets in fluid communication with the one or more inlets via a fluid passageway in the first profile portion and/or the second profile portion,
   and wherein a flow of fluid through the fluid passageway is configured to alter the temperature of the first profile portion and/or the second profile portion.

### TECHNICAL FIELD

The present invention relates to an apparatus for forming a blank. In particular, the present invention relates to an apparatus for forming a blank using a platen press.

### BACKGROUND

Presses having multiple moving platens are commonly used to process sheet material, such as rubber, plastic, paper and wood products. In some types of platen press, the platens are heated during the processing cycle.

In platen presses that are used to produce laminate materials comprising multiple layers, the heating of the layers by the heated platens can result in the expansion of air or other gasses trapped between the layers (or within a layer if foamed material is being used). This can result in bubbles forming in the surface layers of the laminate materials, which is not only unsightly, but which may also compromise the performance and longevity of the laminate materials.

In some manufacturing processes, materials formed using platen presses (such as laminate materials) must be transferred between different types of presses. For instance, some materials may be transferred from a heated platen press to a cold platen press or continue on to another manufacturing process. Presently, the transfer of materials into or out of platen presses is inefficient (particularly for multi daylight presses), resulting in increased manufacturing costs and times.

Thus, there would be an advantage if it were possible to provide an apparatus for use with a platen press that reduced or eliminated the formation of bubbles in laminate materials. In addition, there would be an advantage if it were possible to provide an apparatus for use with a platen press that improved the efficiency with which materials could be transferred into, our of or between platen presses (such as multi daylight presses) in order to reduce manufacturing costs and/or times.

It will be clearly understood that, if a prior art publication is referred to herein, this reference does not constitute an admission that the publication forms part of the common general knowledge in the art in Australia or in any other country.

### SUMMARY OF INVENTION

Embodiments of the present invention provide a method and apparatus for forming a blank, which may at least partially address one or more of the problems or deficiencies mentioned above or which may provide the public with a useful or commercial choice.

With the foregoing in view, in a first aspect the present invention resides broadly in a profiled press plate for forming a blank from two or more layers of sheet material in a platen press, comprising:
a plate portion comprising a first profile portion on a surface thereof, the first profile portion being configured to compress the two or more layers of sheet material to form a seal therebetween about at least a portion of a periphery of the blank, the plate portion further comprising a second profile portion on a surface thereof, the second profile portion being located inwardly of the first profile portion and configured to compress the two or more layers of sheet material to form fold lines therein,
wherein the profiled press plate includes one or more inlets in fluid communication with a source of fluid and one or more outlets in fluid communication with the one or more inlets via a fluid passageway in the first profile portion and/or the second profile portion,
and wherein a flow of fluid through the fluid passageway is configured to alter the temperature and/or the pressure of the first profile portion and/or the second profile portion.

The profiled press plate may be of any suitable form. In a preferred embodiment of the invention, however, the profiled press plate may be heated via a press platen or other heat source. It will be understood that the heating of the platen is conventional, and no further discussion of this is required.

The profiled press plate may be of any suitable size and shape. Typically, however, the profiled press plate will be substantially rectangular. It will be understood that the size of the profiled press plate will be dependent on the size of the blank to be produced, and the thickness of the profiled press plate and the width of the contact face may vary depending on the nature of the blank to be produced.

The profiled press plate may be fabricated from any suitable material. Preferably, however, the platen may be at least partially fabricated from a metal or combination of metals. In a preferred embodiment of the invention, the profiled press plate may be at least partially fabricated from aluminium.

In a preferred embodiment of the invention, the profiled press plate may include a substantially planar surface from which the first profile portion and the second profile portion extend. Preferably, the first profile portion and the second profile portion extend outwardly from the planar surface of the platen. In one embodiment of the invention, the first profile portion and/or the second profile portion may extend from the substantially planar surface at an angle substantially perpendicular thereto.

The first profile portion may be of any suitable form. As previously stated, the first profile portion is configured to compress the two or more layers of sheet material to form a precompression area therebetween about at least a portion of the periphery of the blank. The first profile portion may be located at or adjacent the periphery of the substantially planar surface of the platen. Alternatively, the first profile portion may be spaced inwardly from the periphery of the substantially planar surface of the platen along at least a portion of its length.

In some embodiments of the invention, the blank may be provided in the form of a regular polygon. In these embodiments, the shape of the first profile portion may therefore also be in the form of a regular polygon. Alternatively, however, the periphery of the blank may be in the form of an irregular polygon. Thus, in this embodiment, the shape of the first profile portion may also be in the form of an irregular polygon. Thus, portions of the first profile portion may be located at a different orientation to other portions of the first profile portion. In addition, portions of the first profile portion may be spaced from the periphery of the substantially planar surface of the platen at different distances to other portions of the first profile portion.

In a preferred embodiment of the invention, the first profile portion may extend substantially entirely about the periphery of the blank. In this way, the first profile portion may form a precompression about substantially the entire periphery of the blank.

The first profile portion may comprise one or more first profile members associated with one another in order to form the first profile portion in the shape of the periphery of the blank. Any suitable number of first profile members may be provided, and it will be understood that the number of first profile members, and their orientation relative to one another, may be determined by the desired shape of the periphery of the blank to be produced.

In embodiments of the invention in which two or more first profile members are provided, the first profile members may be associated with one another using any suitable technique. For instance, the first profile portion may be formed as a unitary structure. In other embodiments, the two or more first profile members may be formed separately to one another and configured for fixed or removable connection to one another. In a preferred embodiment, the two or more first profile members may be configured for fixed connection to one another, such as by welding or the like.

The first profile portion may be connected to the substantially planar surface of the platen using any suitable technique. For instance, the first profile portion may be formed integrally with the substantially planar surface of the platen. In other embodiments, the first profile portion may be fabricated separately to the substantially planar surface of the platen and configured for fixed or removable connection thereto. The first profile portion may be connected to the platen using any suitable technique, such as by using one or more mechanical fasteners, adhesives, or by welding or similar process.

It will be understood that the first profile portion may be at least in part spaced inwardly from the periphery of the substantially planar surface of the platen. In this embodiment, the sheet material may have a larger area than that of the blank formed by the platen such that the periphery of the blank is spaced inwardly from the periphery of the sheet material. It is envisaged that, in these situations, the blank formed by the platen may be cut, stamped or otherwise removed from the sheet material.

In some embodiments of the invention, the first profile portion may extend outwardly from the substantially planar surface of the platen the same distance as the second profile portion. In other embodiments of the invention, the first profile portion may extend outwardly from the substantially planar surface of the platen a greater distance than the second profile portion. In this embodiment of the invention, as the platen is brought into abutment with the sheet material in order to form the blank, the first profile portion may contact the sheet material prior to the second profile portion, which may allow for additional compression (and therefore improved precompression area formation) of the sheet material by the first profile portion.

In embodiments of the invention in which the platen is heated, it is envisaged that the formation of the precompression area about at least a portion of the blank by the first profile portion may be achieved through a combination of pressure applied to the sheet material by the first profile portion and the relatively high temperature of the first profile portion.

The second profile portion may be of any suitable size, shape or configuration. As previously stated, the second profile portion is configured to compress the two or more layers of sheet material to form fold lines therein. Thus, the second profile portion may comprise one or more second profile members configured to form fold lines at desired locations on the sheet material. Any suitable number of second profile members may be provided, and it will be understood that the number of second profile members, and their orientation relative to one another, may be determined by the number and location of fold lines to be formed in the sheet material.

In embodiments of the invention in which two or more second profile members are provided, the second profile members may be associated with one another using any suitable technique. For instance, the second profile portion may be formed as a unitary structure. In other embodiments, the two or more second profile members may be formed separately to one another and configured for fixed or removable connection to one another. In a preferred embodiment, the two or more second profile members may be configured for fixed connection to one another, such as by welding or the like.

The second profile portion may be connected to the substantially planar surface of the platen using any suitable technique. For instance, the second profile portion may be formed integrally with the substantially planar surface of the platen. In other embodiments, the second profile portion may be fabricated separately to the substantially planar surface of the platen and configured for fixed or removable connection thereto. The second profile portion may be connected to the platen using any suitable technique, such as by using one or more mechanical fasteners, adhesives, or by welding or similar process.

In other embodiments of the invention, the second profile portion may be connected to the first profile portion. The second profile portion may be formed integrally with the first profile portion or may be formed separately thereto and configured for fixed or removable connection thereto using any suitable technique (such as by using one or more mechanical fasteners, adhesives, or by welding or similar process). Thus, it is envisaged that at least a portion of the second profile portion may be located in abutment with the first profile portion.

In a preferred embodiment, the first and second profile members may be configured for fixed connection to one another by cutting the profile from a single sheet of material or the like. This profile may be termed a ‘profiled press plate’ and may be attached to a platen as an independent unit.

As previously stated, the second profile portion is located inwardly of the first profile portion. By this it is meant that the second profile portion is located towards the centre of the substantially planar surface of the platen from the first profile portion. In this way, the first profile portion is configured to define the periphery of the blank, and the second profile portion is configured to form fold lines in the sheet material inside the periphery of the blank.

In embodiments of the invention in which the platen is heated, it is envisaged that the formation of the fold lines by the second profile portion may be achieved through a combination of pressure applied to the sheet material by the second profile portion and the heat transferred by the relatively high temperature of the second profile portion.

As previously stated, the profiled press plate includes one or more inlets in fluid communication with a source of fluid. The one or more inlets may be of any suitable form, and the exact nature of the one or more inlets is not critical to the invention. The source of fluid may be of any suitable form, such as a reservoir, bottle (including a gas bottle), tank, blower or the like. The one or more inlets may be provided in the first profile portion, the second portion or both.

The fluid may be a liquid or gas, although in a preferred embodiment of the invention, the liquid may be a gas. Any suitable gas may be used, although in a preferred embodiment the gas may be air. In a specific embodiment of the invention, the gas may be compressed air.

The fluid passageway in the first profile portion and/or second profile portion may be of any suitable form. In some embodiments of the invention, the fluid passageway may extend through all parts of the first profile portion and/or the second profile portion. In other embodiments, the fluid passageway may extend through a portion of the first profile portion only and/or a portion of second profile portion only.

Preferably, the fluid passageway may be formed at the interior of the first profile portion and/or the second profile portion. In this embodiment of the invention, it is envisaged that at least a portion of the first profile members that form the first profile portion and/or the one or more second profile members that form the second profile portion may be substantially hollow. In this embodiment, the hollow interior of the first profile members and/or the one or more second profile members may form the fluid passageway.

The fluid passageway may be substantially linear from the one or more inlets to the one or more outlets. Alternatively, the fluid passageway may have a tortuous path. In some embodiments of the invention, the fluid passageway may include one or more closure members therewithin. It is envisaged that, in this embodiment, the one or more closure members may be opened or closed to allow or preclude fluid from flowing therethrough. Thus, it is envisaged that the length and path of the fluid passageway may be altered depending on the desired outcome. The one or more closure members may be of any suitable form, and may include one or more gates, valves or the like.

The one or more outlets may be of any suitable form, and the exact nature of the one or more outlets is not critical to the invention. The one or more outlets may be located in the first profile portion, the second profile portion, or both. In some embodiments of the invention, the fluid exiting the first profile portion and/or the second profile portion through the one or more outlets may be captured in a vessel (such as a reservoir, tank, bottle or the like). In these embodiments, the fluid may be captured for re-use, for use in a different application, or for disposal. In other embodiments, the fluid may be released to the atmosphere through the one or more outlets.

In a preferred embodiment, the fluid may be contained in the first profile portion and/or the second profile portion using one or more containment members. Any suitable containment members may be used, such as, but not limited to, one or more backing plates and/or seals.

In a preferred embodiment of the invention, the fluid flowing through the fluid passageway is relatively cool compared to the temperature of the profiled press plate. In addition, the flow rate of fluid in and out of the profiled press plate may be regulated. In this way, the fluid may be used to cool the portion of the first profile portion and/or the second profile portion in which the fluid passageway is located. In addition, it is envisaged that the flow of fluid through the fluid passageway may create additional pressure on the sheet material during the formation of the blank. It is envisaged that providing fluid at pressures above atmospheric pressure in the fluid passageway may suppress the formation of bubbles in the sheet material during formation of the blank. The fitment of a backing sheet to the profiled press plate using a gasket material allows an airtight seal to be formed when the profiled press plate pushes on the sheet material (such as laminated foam sheet) during a press compression cycle. It is envisaged that the fitment of the gasket material to the profiled press plate may form one or more sealed sections on the sheet material, the one or more sealed sections being bounded by at least a portion of the first profile portion and/or the second profile portion. Preferably, the sheet material may be pressurised and/or cooled by the fluid. More specifically, one or more regions of the sheet material bounded by the first profile portion and/or the second profile portion (such as, but not limited to, the one or more sealed portions) may be pressurised and/or cooled by the fluid. Preferably, each of the first profile portion and the second profile portion are pressurised by fluid flow through said inlets. It is envisaged that generating a relatively high pressure (and, in particular, a greater than atmospheric pressure) in the one or more sealed sections may assist in reducing or eliminating the formation of bubbles in the sheet material within the one or more sealed sections.

In a preferred embodiment of the invention, the inclusion of a low thermal conductive material (such as those fabricated from polyoxybenzylmethylenglycolanhydride (known colloquially as Bakelite) or similar that is fixed to the profiled press plate backing plate between profiles may provide thermal shielding to the material being processed and may assist fluid flowing through the fluid passageway to remain relatively cool compared to the temperature of the heated platen. It is envisaged that the formation of bubbles in the sheet material between the profile portions may further be reduced or eliminated through a combination of thermal shielding and cooling from the fluid.

Preferably, the selective cooling of the first profile portion and/or the second profile portion and/or the additional pressure (i.e., pressure above atmospheric pressure) generated by the fluid (particularly when the fluid is a pressurised fluid) may result in reduced delamination of the layers of sheet material in the blank, as well as a reduction in bubbles formed in the surface of the formed blank. Thus, the present invention provides a significant advantage.

In a second aspect, the invention resides broadly in a transfer mechanism for a platen press, the transfer mechanism comprising:
A first connection member pivotally connected to a first platen at a first end thereof, and to a base member at an opposed second end thereof;
A second connection member pivotally connected to a second platen at a first end thereof, and to the base member at an opposed second end thereof;
A transfer member associated with the base member and movable relative thereto, the transfer member further being associated with a material carrying member configured to carry one or more sheets of sheet material thereon,
Wherein movement of the transfer member relative to the base member moves the material carrying member between a use condition in which the material carrying member is located substantially between the first platen and the second platen, and a release condition in which the material carrying member is moved away from the first platen and the second platen.

The platen press may be of any suitable form. Preferably, however, the platen press comprises the first platen and the second platen that are brought together to form a product. A specific example of this may include a multi daylight press comprising a plurality of platens. It is envisaged that, in the present invention, the product is fabricated from the one or more sheets of sheet material that are carried by the material carrying member. In these embodiments, it is envisaged that the first platen and the second platen (and additional platens, if present) may apply heat and/or pressure to the one or more sheets of sheet material in the use condition in order to form the product.

In some embodiments of the invention, the first platen and the second platen may be conventional. In other embodiments the first platen and/or the second platen may be or include the profiled press plate of the first aspect of the invention.

The first connection member may be of any suitable form. Preferably, however, the first connection member may be of a type that provides for pivoting of the first connection member relative to the first platen. In a preferred embodiment of the invention, the first connection member may also be pivotally connected to the base member. In some embodiments of the invention, the first connection member may comprise a pivot joint or a ball joint. More preferably, however the first connection member may comprise a rod end bearing (also known as a heim joint or rose joint). In some embodiments, these may be linked by a jackscrew. More specifically, the first connection member may comprise a rod end bearing connected to the first platen and a shaft extending from the rod end bearing to the base member, which may further support a linear bearing carriage and an associated shaft.

The second connection member may be of any suitable form. Preferably, however, the second connection member may be of a type that provides for pivoting of the second connection member relative to the second platen. In a preferred embodiment of the invention, the second connection member may also be pivotally connected to the base member. In some embodiments of the invention, the second connection member may comprise a pivot joint or a ball joint. More preferably, however the second connection member may comprise a rod end bearing (also known as a heim joint or rose joint). In some embodiments, these may be linked by a jackscrew. More specifically, the second connection member may comprise a rod end bearing connected to the second platen and a shaft extending from the rod end bearing to the base member, which may further support a linear bearing carriage and an associated shaft.

It is envisaged that the first connection member and the second connection member may pivot simultaneously. Preferably, the first connection member and the second connection member may pivot simultaneously in opposite directions to one another. Preferably, when the first connection member and the second connection pivot in a first opposite direction to one another, the first platen and the second platen may be brought into abutment, or at least relatively close proximity, to one another. When the first connection member and the second connection member pivot in a second opposite direction to one another, the first platen member and the second platen member may be moved apart from one another.

In a preferred embodiment of the invention, the first connection member may also be pivotally connected to the base member. In some embodiments of the invention, the first connection member may comprise a pivot joint or a ball joint. More preferably, however, the first connection member may comprise a rod end bearing (also known as a heim joint or rose joint). More specifically, the first connection member may comprise a rod end bearing connected to the first platen and an adjustable linkage (preferably a left and right hand jackscrew) extending from the rod end bearing to a second connection member and supporting a linear bearing carriage via the base member. The linear bearing carriage may support a shaft that may be connected and supported by another set of first and second connection members and an associated bearing carriage member as previously described. For instance, a first and second set of rod end bearing connections at the base member may connect to bearing blocks supporting a horizontal shaft fitted with end mounting plates connected to a support bracket, or to a portion thereof, which connects to a material transfer plate through a bearing channel. The support bracket may have additional horizontal bearing blocks fitted to support a drive shaft or the like as well as additional vertical bearing block each end of transfer plate to maintain sideways positioning relative to press platen and attached profiled press plates. One or more drive shafts may be provided with a circular gear such as a pinion on the ends thereof that may engage with a drive rack, thereby allowing the material transfer plate to fully extend outwards both sides of the platen press in a controlled manner using any suitable technique.

The transfer member may be of any suitable form, and may be associated with base member in any suitable manner. For instance, the transfer member may move telescopically relative to the base member. Similarly, the transfer member may be configured for pivoting, hinged or rotating movement relative to the base member.

More preferably, however, the transfer member may be configured for sliding or ratcheting movement relative to the base member. Preferably, the transfer member may move in a substantially linear manner between the use condition and the release condition.

In embodiments of the invention in which the transfer member moves in a substantially linear manner relative to the base member, it is envisaged that the transfer member may comprise one or more bearing channels and one or more bearing carriages. In these embodiments, the base member may comprise a bearing channel, and the transfer member may pass at least partially through the base member. In a particular embodiment of the invention, the base member may comprise a bearing channel in which bearing carriages can exit from either end thereof. In this embodiment, the transfer member may have a substantially square cross-sectional shape.

In a preferred embodiment, movement of the transfer member into the use condition may actuate movement of the first platen and the second platen towards one another. Similarly, movement of the transfer member into the release condition may actuate movement of the first platen and the second platen away from one another.

Movement of a transfer member (particularly in a multi daylight press) may actuate movement of the platen directly below and the platen directly above in any suitable manner. For instance, the transfer member may be provided with one or more actuation members that interact with the bearing channel, the bearing carriages and/or the rack and pinion drive.

The material carrying member may be of any suitable form. As previously stated, however, the material carrying member is configured to carry one or more sheets of sheet material thereon. It is envisaged that the one or more sheets of sheet material may be used to form a product in the platen press when the material carrying member is in the use condition. It is envisaged that, in the use condition, the first platen and the second platen may be brought into abutment with opposed faces of the material carrying member, thereby compressing the one or more sheets of sheet material therebetween to form a product.

In a preferred embodiment of the invention, the material carrying member may be provided in the form of a plate member having opposed substantially planar first and second faces. In some embodiments of the invention, one or more sheets of sheet material may be carried on each of the first face and the second face of the material carrying member. In this way, two products may be formed simultaneously in the platen press in the use condition. The first product may be formed between the first platen and the first face of the material carrying member, while the second product may be formed between the second platen and the second face of the material carrying member.

The one or more sheets of sheet material may be retained on the material carrying member as it moves from the release condition to the use condition (and vice versa) using any suitable technique. For instance, one or more mechanical fasteners (clips, pins or the like) may be provided in order to retain the sheets of sheet material on the material carrying member.

In some embodiments of the invention, the first face and/or the second face of the material carrying member may be provided with one or more apertures therein. In this embodiment, the suction force through the one or more apertures may be achieved using any suitable technique. For instance, it is envisaged that the material carrying member may be associated with one or more suction devices configured to draw air through the one or more apertures and into the material carrying member, thereby creating suction that retains the one or more sheets of sheet material in abutment with the material carrying member. Any suitable suction device may be used, such as a pump, vacuum generator, or the like.

It is envisaged that, in the release condition, one or more sheets of sheet material may be located on the material carrying member. The material carrying member may then be moved into the use condition in which the material carrying member is located between the first platen and the second platen (and preferably located substantially centrally between the first platen and the second platen), and pressure is applied by the first plate and/or the second platen to the one or more sheets of sheet material located on the first and/or second faces of the material carrying member to form a product. Once the product is formed, the material carrying member may be returned to the release condition.

In some embodiments, a single material carrying member may be associated with the platen press. In this embodiment, it is envisaged that the product or products formed in the platen press may be removed from the material carrying member in the release condition, and new sheets of sheet material may be located on the material carrying member prior to the material carrying member being returned to the use condition.

In some embodiments of the invention, it is envisaged that a plurality of platen presses may be provided in a stacked arrangement (such as in a multi daylight press). In this embodiment, one or more further platens may be located on either side of the first platen and/or the second platen. In this embodiment, each platen in the stack (other than the platens at the outside ends of the stack) may be double sided. It is envisaged that a material carrying member may be moved into a use condition between each adjacent platen such that a plurality of products may be formed simultaneously.

In some embodiments, a first connection member, second connection member, base member and transfer member may be associated with each material carrying member associated with the stack. In other embodiments, a first connection member, second connection member, base member and transfer member may be associated with a portion of the platens in the stack. In further embodiments, a first connection member, second connection member, base member and transfer member may be associated with one pair of platens in the stack.

In a third aspect, the present invention resides in a material carrying member for use in a platen press, the material carrying member comprising:
a first substantially planar face and an opposed second substantially planar face, each of the first substantially planar face and the second substantially planar face being configured to carry one or more sheets of sheet material thereon; and
one or more apertures located in each of the first substantially planar face and the second substantially planar face,
wherein a suction force is configured to be applied to the material carrying member, the suction force configured to draw air through the one or more apertures into the material carrying member such that the one or more sheets of sheet material are retained on the first substantially planar face and the second substantially planar face.

In some embodiments, it is envisaged that the first substantially planar face and/or the second substantially planar face of the material carrying member may be configured to carry a sheet of composite material such as aluminium, silicon rubber and PTFE tape to enhance precompression and fold line outcomes.

In some embodiments of the invention, it is envisaged that an aluminium profile may be fitted over the silicon rubber to limit heat loss from the heated profiled press plate through to the material carrying member.

In another embodiment of the invention, it is envisaged that the aluminium profile may be fitted with an additional heating source (such as, but not limited to, an impulse heating band) to promote a higher level of precompression and shorter cycle times.

In a fourth aspect of the invention, the present invention resides in a blank formed using the profiled press plate of the first aspect.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of Invention in any way. The Detailed Description will make reference to a number of drawings as follows:

FIG. 1 illustrates a detailed view of a blank formed by a prior art process.

FIG. 2 illustrates a profiled press plate according to an embodiment of the present invention.

FIG. 3 illustrates a detailed view of a profiled press plate according to an embodiment of the present invention.

FIG. 4 illustrates a blank formed using a profiled press plate according to an embodiment of the present invention.

FIG. 5 illustrates a profiled press plate according to an embodiment of the present invention.

FIG. 6 illustrates a material carrying member according to an embodiment of the present invention.

FIG. 7 illustrates a transfer mechanism for a platen press according to an embodiment of the present invention.

### DETAILED DESCRIPTION

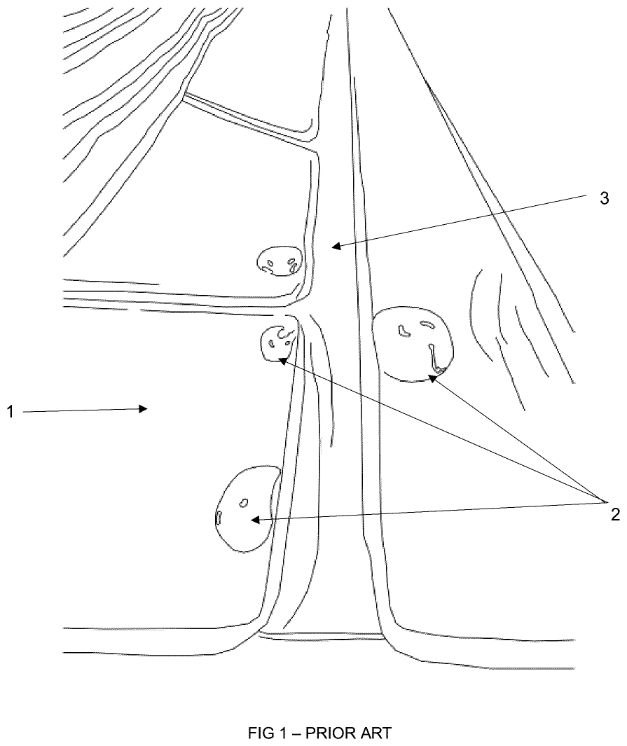

FIG. 1 illustrates a detailed view of a sheet material 1 formed by a prior art process. In this Figure it may be seen that bubbles 2 may be formed in the sheet material 1 adjacent precompression areas 3. These air bubbles 2 are not only unsightly but may reduce the service life and/or the performance of a product formed from the sheet material 1.

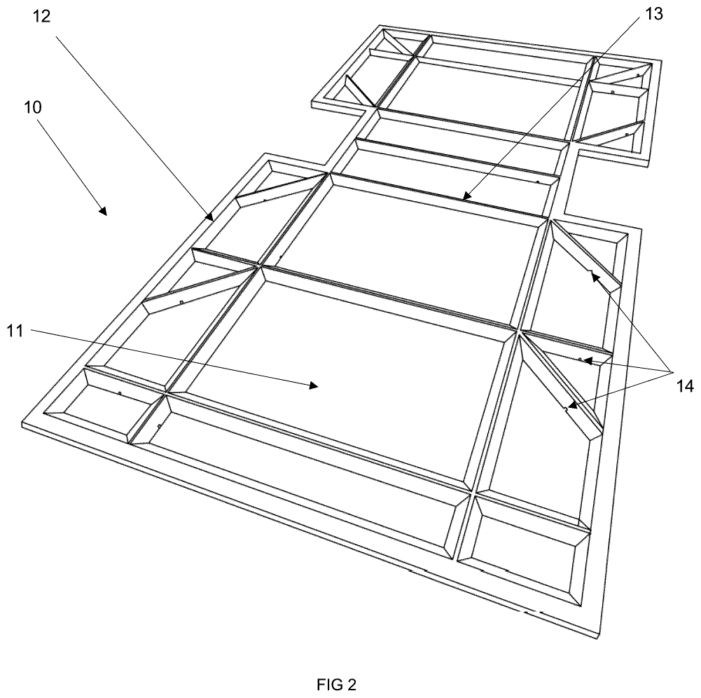

FIG. 2 illustrates a profiled press plate 10 according to an embodiment of the present invention. The profiled press plate 10 comprises a plate portion 11 having a first profile portion 12 configured to compress two or more layers of sheet material to form a seal therebetween about at least a portion of a periphery of a blank, the plate portion 11 further comprising a second profile portion 13 on a surface thereof, the second profile portion 13 being located inwardly of the first profile portion 12 and configured to compress the two or more layers of sheet material to form fold lines therein. The profiled press plate 10 includes a plurality of inlets 14 in fluid communication with a source of fluid (not shown) and one or more outlets (not shown) in fluid communication with the one or more inlets 14 via a fluid passageway (obscured) in the first profile portion 12 and/or the second profile portion 13.

The profiled press plate 10 is fabricated from aluminium. It will be seen that the first profile portion 12 extends substantially about the periphery of the plate portion 11, while the second profile portion 13 comprises a plurality of second profile portion members that are located inside the periphery of the plate portion 11 as defined by the first profile portion 12.

The fluid that enters the first profile portion 12 and the second profile portion 13 increases fluid pressure within the fluid passageway (obscured) to greater than atmospheric pressure. In this way, reduced delamination of the layers of sheet material (not shown) in the blank (not shown) may be achieved, as well as a reduction in bubbles formed in the surface of the formed blank (not shown).

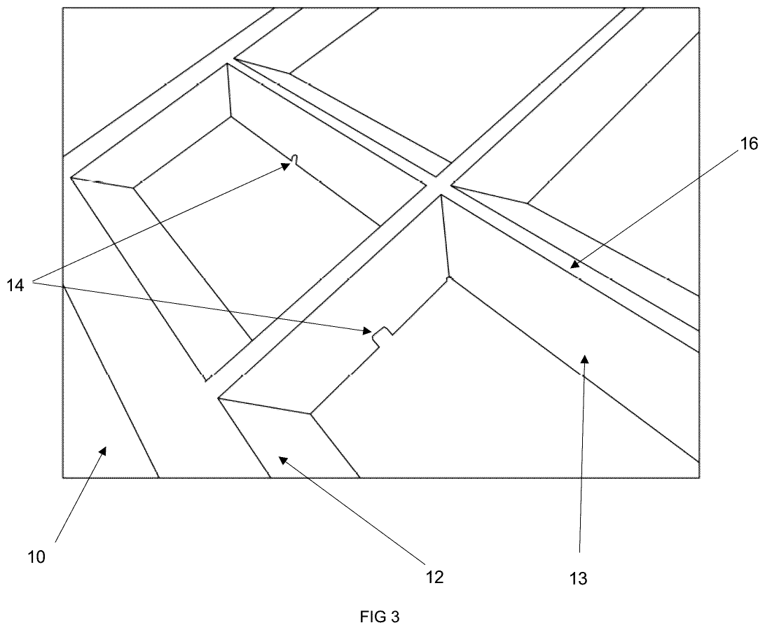

FIG. 3 illustrates a detailed view of a profiled press plate 10 according to an embodiment of the present invention. The profiled press plate 10 is identical to that shown in FIG. 2.

In FIG. 3, the first profile portion 12 is used to create an area of precompression in the sheet material (not shown), while the second profile portion 13 is used to create fold lines in the sheet material (not shown). It will be seen that the second profile portion 13 includes a contact face 16 that, in use, is placed in abutment with the sheet material (not shown). The width of the contact face 16 may be varied depending on the design of the blank to be formed, and the thickness of the sheet material used to form the blank.

In FIG. 3, the inlets 14 in the second profile portion 13 may be more clearly seen.

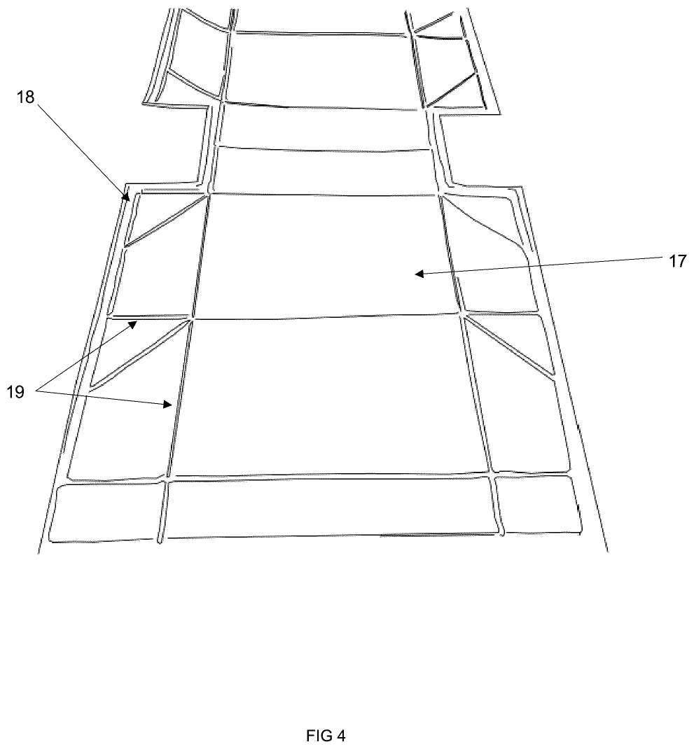

FIG. 4 illustrates a blank 17 formed using a profiled press plate according to an embodiment of the present invention. It may be seen that the blank 17 includes a precompression area 18 about the periphery thereof formed by the first profile portion of the profiled press plate. The blank 17 further comprises fold lines 19 formed by the second profile portion of the profiled press plate.

It will be noted that, during the manufacture of the blank 17, no bubbles have formed on the surface thereof. This is because of the heat and/or greater than atmospheric pressure of the fluid within the fluid passageway of the first profile portion and/or the second profile portion of the profiled press plate.

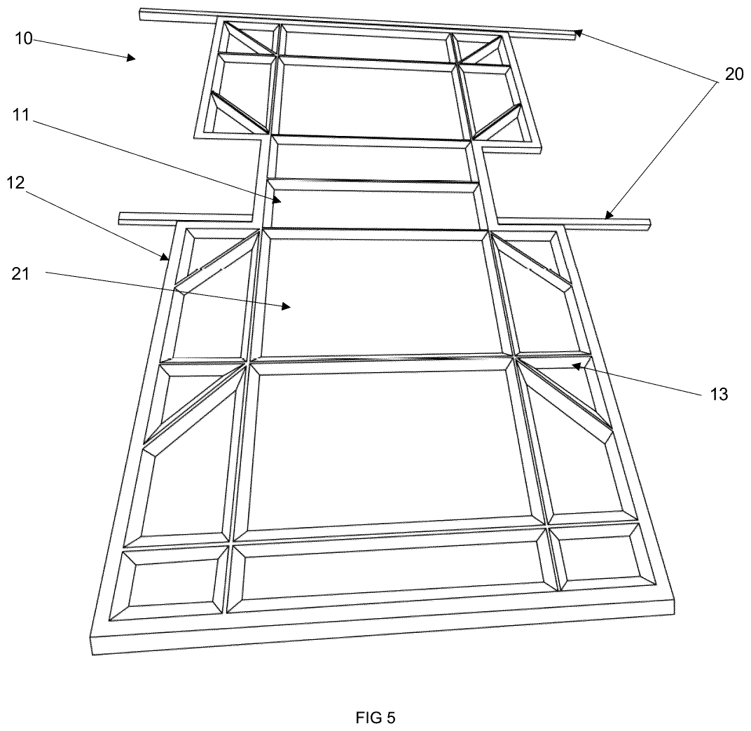

FIG. 5 illustrates a profiled press plate 10 according to an embodiment of the present invention. The profiled press plate 10 of FIG. 5 is similar to that shown in FIG. 2 except that a plurality of mounting members 20 are mounted to the profiled press plate 10 of FIG. 5. Thus, the profiled press plate 10 of FIG. 5 is configured for attachment to a platen (not shown).

In FIG. 5, a material 21 having a relatively low thermal conductivity is applied to the plate portion 11 of the profiled press plate 10. The material 21 is applied to the plate portion 11 between members of the first profile portion 12 and the second profile portion 13. The use of the material 21 provides thermal shielding to the sheet material (not shown) used to form a blank. In is this embodiment of the invention, the material 21 is polyoxybenzylmethylenglycolanhydride (known colloquially as Bakelite) provided in the form of a sheet material or fabric.

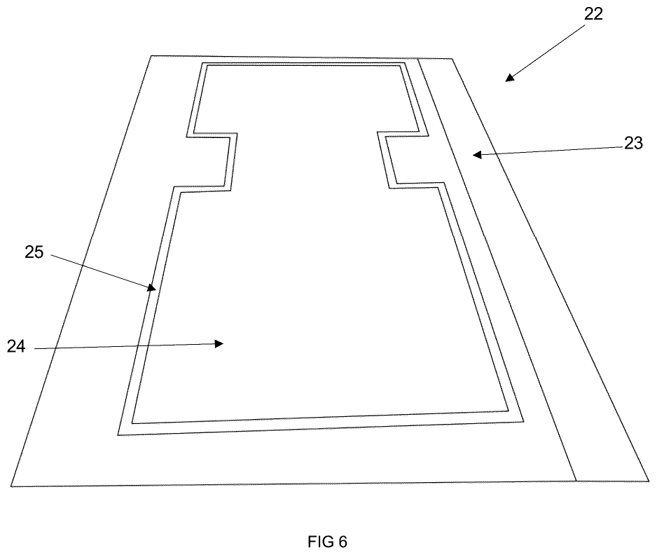

FIG. 6 illustrates a material carrying member 22 according to an embodiment of the present invention. The material carrying member 22 includes a first substantially planar face 23 and an opposed second substantially planar face (obscured), each of the first substantially planar face 23 and the second substantially planar face (obscured) being configured to carry one or more sheets of sheet material (not shown) thereon.

The material carrying member 22 further comprises apertures (not shown) located in each of the first substantially planar face 23 and the second substantially planar face (obscured). A suction force is applied to the material carrying member 22 through the one or more apertures to draw air through the one or more apertures (not shown) into the material carrying member 22 such that the one or more sheets of sheet material are retained on the first substantially planar face 23 and the second substantially planar face (obscured).

In the embodiment of the invention shown in FIG. 6, the planar face (obscured) is provided with a base layer 24 comprising a silicone sheet, the base layer 24 configured to provide a substantially planar surface against which the sheet material is pressed. An aluminium profile 25 is fitted over a portion of the base layer 24. The profile 25 defined the periphery of the blank to be formed, and is configured to provide a press surface against which a precompression profile portion of a profiled press plate (such as the profiled press plate of FIG. 2) can apply pressure during formation of a blank.

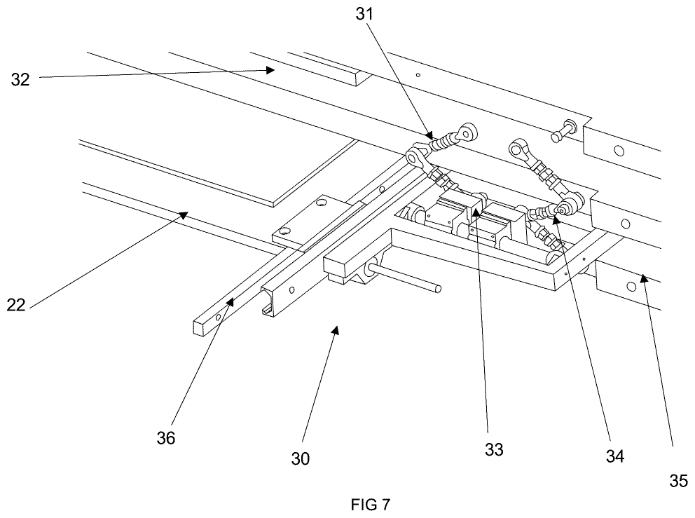

FIG. 7 illustrates a transfer mechanism 30 for a platen press according to an embodiment of the present invention. The transfer mechanism 30 comprises a first connection member 31 pivotally connected to a first platen 32 at a first end thereof, and to a base member 33 at an opposed second end thereof. The transfer mechanism 30 further comprises a second connection member 34 pivotally connected to a second platen 35 at a first end thereof, and to the base member 33 at an opposed second end thereof.

The transfer mechanism 30 further includes a transfer member 36 associated with the base member 33 and movable relative thereto, the transfer member 36 further being associated with a material carrying member 22 configured to carry one or more sheets of sheet material thereon.

In use, the transfer member 36 is configured for movement relative to the base member 33 in order to move the material carrying member 22 between a use condition (as shown in FIG. 7) in which the material carrying member 22 is located substantially between the first platen 32 and the second platen 35, and a release condition in which the material carrying member 22 is moved away from the first platen 32 and the second platen 35.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

What is claimed is:

1. A profiled press plate for forming a blank from two or more layers of sheet material in a platen press, comprising:
a plate portion comprising a first profile portion on a surface thereof, the first profile portion being configured to compress the two or more layers of sheet material to form a seal therebetween about at least a portion of a periphery of the blank, the plate portion further comprising a second profile portion on a surface thereof, the second profile portion being located inwardly of the first profile portion and configured to compress the two or more layers of sheet material to form fold lines therein,
wherein the profiled press plate includes one or more inlets in fluid communication with a source of fluid and one or more outlets in fluid communication with the one or more inlets via a fluid passageway in the first profile portion and/or the second profile portion,
and wherein a flow of fluid through the fluid passageway is configured to alter the temperature of the first profile portion and/or the second profile portion.

2. The profiled press plate according to claim 1, wherein one or more regions of the sheet material bounded by the first profile portion and/or the second profile portion are pressurised and/or cooled by the fluid.

3. The profiled press plate according to claim 1, wherein the plate portion includes a substantially planar surface from which the first profile portion and the second profile portion extend.

4. The profiled press plate according to claim 3, wherein the first profile portion and/or the second profile portion extend from the substantially planar surface at an angle substantially perpendicular thereto.

5. The profiled press plate according to claim 3, wherein the first profile portion is spaced inwardly from a periphery of the substantially planar surface along at least a portion of its length.

6. The profiled press plate according to claim 1, wherein the first profile portion extends substantially about a periphery of the blank, such that the first profile portion forms a precompression area about substantially the entire periphery of the blank.

7. The profiled press plate according to claim 6 wherein the precompression area is formed through a combination of pressure applied to the sheet material by the first profile portion and a relatively high temperature of the first profile portion.

8. The profiled press plate according to claim 7 wherein the first profile portion comprises one or more first profile members associated with one another in order to form the first profile portion in the shape of the periphery of the blank.

9. The profiled press plate according to claim 3, wherein the first profile portion extends outwardly from the substantially planar surface of the press plate a greater distance than the second profile portion.

10. The profiled press plate according to claim 1, wherein the second profile portion comprises one or more second profile members configured to form fold lines in the sheet material.

11. The profiled press plate according to claim 10 wherein the second profile portion is configured to form fold lines in the sheet material through a combination of pressure applied to the sheet material by the second profile portion and a relatively high temperature of the second profile portion.

12. The profiled press plate according to claim 1, wherein the fluid comprises compressed air.

13. The profiled press plate according to claim 1, wherein the fluid passageway includes one or more closure members therewithin, the one or more closure members configured to be opened or closed to allow or preclude fluid from flowing therethrough.

14. The profiled press plate according to claim 1, wherein the fluid is contained in the first profile portion and/or the section profile portion using one or more containment members.

15. A blank formed using the profiled press plate of claim 1.
